(19) United States
(12) Patent Application Publication
(10) Pub. No.: US 2008/0106490 A1
(43) Pub. Date: May 8, 2008

(54) Video display device

(75) Inventor: Yasushi Tanabe, Minami-Ashigara-shi (JP)

Correspondence Address: BUCHANAN, INGERSOLL & ROONEY PC, POST OFFICE BOX 1404, ALEXANDRIA, VA, 22313-1404, US

(73) Assignee: FUJIFILM Corporation, Tokyo (JP)

(21) Appl. No.: 11/905,275

(22) Filed: Sep. 28, 2007

(30) Foreign Application Priority Data
Sep. 28, 2006 (JP) 2006-264879

(51) Int. Cl. G09G 3/00

(52) U.S. Cl. 345/31

(57) ABSTRACT

A video display device includes: a display unit for displaying video information on a screen; and a mechanical vibrating unit for vibrating at least one of constituent members including a light source that exist on an optical path, starting from the light source, of the display unit, mechanically and randomly at a very small amplitude.

### FIELD OF THE INVENTION

The present invention relates to a video display device which displays video information on the screen. In particular, the invention relates to a video display device capable of displaying easy-to-see video information on the screen.

### BACKGROUND OF THE INVENTION

Fixed-pixel video display devices such as liquid crystal TV receivers and plasma TV receivers have spread and their screen sizes have been increasing. And the resolution of video information displayed thereon has been increasing.

When high-resolution video image is displayed on a fixed-pixel video display device, a beautiful image can be displayed which is focused even at the corners of the screen and a viewer tends to fix his or her eyes on the entire screen. This leads to a problem that the eyes of the viewer are fatigued to a larger extent as the screen size increases or he or she watches moving images for a longer time.

In view of the above, in the prior art described in JP-A-2005-184217, video information to be displayed on a video display device is subjected, before being displayed on the screen, to image processing for giving it 1/f fluctuation. Resulting video information is displayed on the screen.

If the video information displayed on the screen has 1/f fluctuation, it is not a hard image which is clear and crisp at every point on the screen but a soft image like an image that is projected on a screen by a film projector. This is effective in suppressing the eye fatigue.

### SUMMARY OF THE INVENTION

The resolution of video information has increased further in recent years, and attempts to establish one-step higher standards for DVDs for storing video information are being made. Furthermore, what is called full-spec high-resolution image data have come to be broadcast in the form of digital broadcast.

As a result, the amount of data per frame of images displayed on the screen is increasing monotonously. Giving 1/f fluctuation to such a large amount of video information by an image processing technique requires an enormous amount of computation.

To give 1/f fluctuation to image data of each frame in real time in displaying a moving image on the screen, a high-performance, expensive image processing device is necessary. This results in a problem that the manufacturing cost of a video display device is increased to a large extent.

An object of the present invention is to provide a video display device capable of displaying easy-to-see video information while suppressing cost increase.

The invention provides a video display device having a display unit for displaying video information on a screen, characterized by comprising a mechanical vibrating unit for vibrating at least one of constituent members including a light source that exist on an optical path, starting from the light source, of the display unit, mechanically and randomly at a very small amplitude.

The video display device according to the invention is characterized by further comprising a 1/f fluctuation generating unit for giving 1/f fluctuation to the very small vibration.

The video display device according to the invention is characterized in that the mechanical vibrating unit is attached to the display unit so as to vibrate the at least one constituent member perpendicularly to or parallel with the optical path at a very small amplitude or to vibrate an angle of the at least one constituent member with respect to the optical path at a very small amplitude.

The video display device according to the invention is characterized in that the mechanical vibrating unit is attached to the display unit so as to vibrate an interval between two of the constituent members at a very small amplitude.

The video display device according to the invention is characterized in that the display unit comprises a backlight and a liquid crystal display panel.

The video display device according to the invention is characterized in that the display unit comprises an organic EL panel.

The video display device according to the invention is characterized in that the display unit comprises a field emission display.

The video display device according to the invention is characterized in that the display unit comprises a plasma display panel.

The video display device according to the invention is characterized in that the display unit comprises a rear projection display.

According to the invention, a constituent member(s) on the optical path is vibrated mechanically at a very small amplitude, a viewer who watches the screen sees fluctuating video and hence is allowed to watch even high-resolution video as a movie-film-like image. Since the circuitry necessary for displaying video information on the screen does not require a special image processing circuit or the like, a video display device can be manufactured at a low cost by using the basic configuration of an existing video display device as it is. Furthermore, according to the invention, no special measure needs to be taken even if the resolution of image data is increased further in the future.

### BRIEF DESCRIPTION OF THE DRAWINGS

FIG. 1 is a block diagram showing the configuration of a main part of a video display device according to a first embodiment of the present invention.

FIG. 2 is a block diagram showing the configuration of a main part of a video display device according to a second embodiment of the invention.

FIG. 3 is a block diagram showing the configuration of a main part of a video display device according to a third embodiment of the invention.

FIG. 4 is an explanatory diagram of a display unit of a video display device according to a fourth embodiment of the invention.

FIG. 5 is an explanatory diagram of a display unit of a video display device according to a fifth embodiment of the invention.

### DESCRIPTION OF SYMBOLS

10, 20, 30: Video display device
11: Video display control section
12, 25: Display unit
13: 1/f fluctuation generator
13a, 13b: Start/stop switch
14, 15: Driver
21: Backlight
22: Liquid crystal display panel
23a, 23b: Piezoelectric element (mechanical vibrating unit)
26: Organic EL panel
27: Fixed stage
31: Field emission display (FED)
32: Back substrate
33: Surface glass substrate

### DETAILED DESCRIPTION OF THE INVENTION

Embodiments of the present invention will be hereinafter described with reference to the drawings.

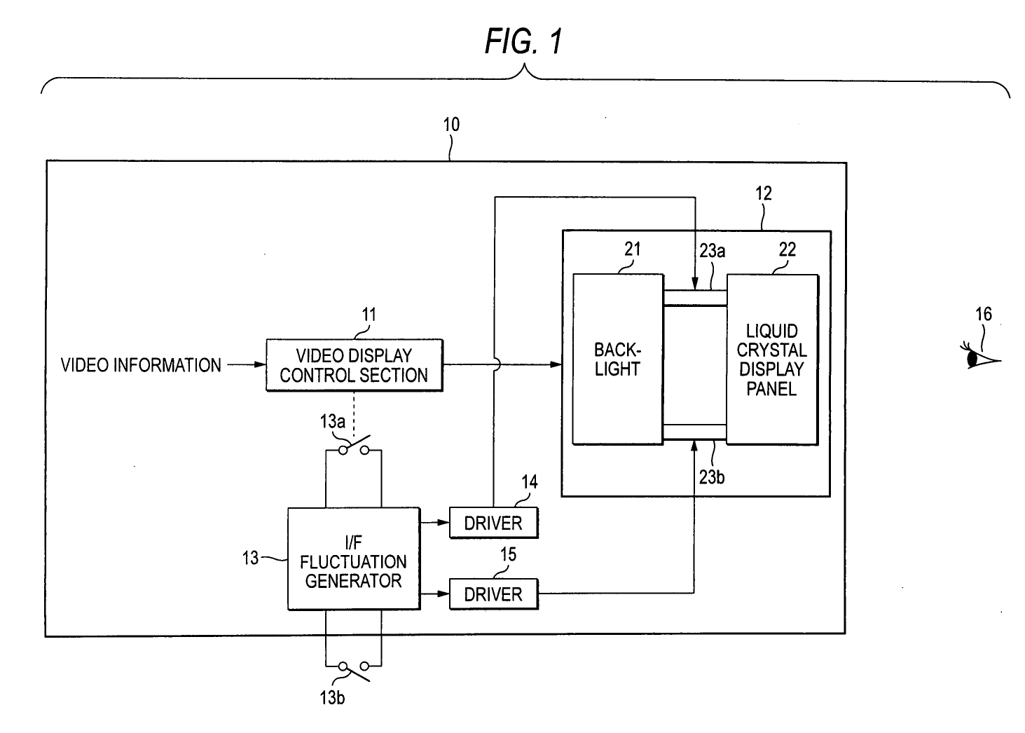

FIG. 1 is a block diagram showing the configuration of a main part of a video display device according to a first embodiment of the invention. Although the embodiment described below is directed to a case that high-resolution video information is supplied in the form of a digital signal, the same advantages can be obtained even if it is supplied in the form of an analog signal.

The video display device 10 according to the embodiment is equipped with a video display control section 11, a display unit 12, a 1/f fluctuation generator 13, and drivers 14 and 15.

The video display control section 11 receives video information from a video information source such as a digital tuner or a DVD reproducing section, generates video data to be displayed on the display unit 12, and outputs the video data to the display unit 12.

The display unit 12, which has the same configuration as ordinary liquid crystal TV receivers, is equipped with a backlight 21 which is shaped like a flat plate and a flat-plate-shaped liquid crystal display panel 22 which is disposed in front of the backlight 21. In this embodiment, the backlight 21 and the liquid crystal display panel 22 are mechanically linked to each other so as to be parallel with each other by means of plural actuators 23a and 23b. For example, the actuators 23a and 23b are piezoelectric elements each of which expands and contracts according to the application voltage.

The pixels of the liquid crystal display panel 22 are open/close-controlled on the basis of video display information that is output from the video display control section 11. Light emitted from the backlight 21 passes through “open” pixels and enters the eyes of a viewer 16.

The 1/f fluctuation generator 13 generates 1/f fluctuation signals on the basis of random numbers generated inside. The drivers 14 and 15 generate voltages according to the 1/f fluctuation signals supplied from the 1/f fluctuation generator 13 and apply the voltages to the piezoelectric elements 23a and 23b.

The 1/f fluctuation generator 13 is quipped with start/stop switches 13a and 13b. The start/stop switch 13a is opened or closed according to a command from the video display control section 11, and the start/stop switch 13b is opened or closed by the viewer 16 manually. When both of the start/stop switches 13a and 13b are closed, the 1/f fluctuation generator 13 outputs 1/f fluctuation signals to the drivers 14 and 15.

In the video display device 10 having the above configuration, the viewer 16 opens the switch 13b if he or she wants to watch video in the form of clear and crisp images. In this case, the 1/f fluctuation generator 13 is rendered in a non-operational state.

The video display control section 11 converts information received from the video information source into displayable information and sends it to the display unit 12. Video is thus displayed on the liquid crystal display panel 22.

In the situation being considered, since the 1/f fluctuation generator 13 is in a non-operational state, no voltages are applied to the piezoelectric elements 23a and 23b. Therefore, the piezoelectric elements 23a and 23b have the same length and the backlight 21 and the liquid crystal display panel 22 are kept parallel with each other with a fixed interval. The viewer 16 can thus watch images having distinct edges even at the corners of the screen.

If the viewer 16 wants to watch a long movie, for example, he or she closes the switch 13b. The video display control section 11 receives digital video information reproduced from a DVD, for example, converts it into information suitable for display, and supplies resulting video information to the display unit 12. At this time, the video display control section outputs a “close” command to the switch 13a.

Since both of the start/stop switches 13a and 13b are closed, the 1/f fluctuation generator 13 generates 1/f fluctuation signals and outputs them to the drivers 14 and 15. The drivers 14 and 15 generate voltages according to the 1/f fluctuation signals and apply the voltages to the piezoelectric elements 23a and 23b.

The piezoelectric elements 23a and 23b expand or contract according to the application voltages. If the application voltages vary according to 1/f fluctuation, the lengths of the piezoelectric elements 23a and 23b also fluctuate.

For example, if the same voltage is applied to the piezoelectric elements 23a and 23b, the interval between the backlight 21 and the liquid crystal display panel 22 is vibrated mechanically while they are kept parallel with each other.

When the interval between them is vibrated mechanically, light that passes through each pixel toward the viewer 16 is blurred and made clear repeatedly, that is, the resolution is modulated. The viewer 16 is allowed to watch movie-film-like high-resolution video and his or her eyes are less fatigued.

For example, where the liquid crystal display panel 22 is connected, by the piezoelectric elements 23a and 23b, to the backlight 21 which is fixed to an external frame, if the voltage applied to only one of the piezoelectric elements 23a and 23b is varied, the inclination angle of the liquid crystal display panel 22 with respect to the backlight 21 is varied. When the inclination angle is varied, the exit angle of light emitted from the backlight 21 with respect to the liquid crystal display panel 22 is oscillated at a very small amplitude. This also allows the viewer 16 to watch movie-film-like high-resolution video as in the above example.

The same advantages are also obtained in the case where the liquid crystal display panel 22 is fixed to an external frame and the inclination angle of the backlight 21 with respect to the liquid crystal display panel 22 is varied.

If the entire circumferential portion of the backlight 21 is mechanically linked to that of the liquid crystal display panel 22 by a number of piezoelectric elements, the liquid crystal display panel 22 can be inclined from the backlight 22 not only in the horizontal or vertical direction but also in an arbitrary direction. If the inclination direction is also controlled according to an 1/f fluctuation signal, the viewer 16 is allowed to watch high-resolution video that is more like a movie film.

In the embodiment of FIG. 1, the interval or the inclination angle between the backlight 21 and the liquid crystal display panel 22 is vibrated mechanically at a very small amplitude according to 1/f fluctuation. For example, another configuration is possible in which one or both of the backlight 21 and the liquid crystal display panel 22 are vibrated mechanically parallel with the screen and the vibration is controlled randomly according to 1/f fluctuation.

The term “vibrated at a very small amplitude (very small vibration))” used herein means a vibration having a maximum amplitude of preferably less than 10%, more preferably less than 1% and still more preferably less than 0.1%, with respect to a lengthwise length of the screen of the display unit 12.

Although the embodiment employs the piezoelectric elements as the actuators for causing very small vibration, the actuators are not limited to piezoelectric elements. Very small vibration may be generated by ordinary motors or the like.

As described above, according to the embodiment, a member existing on the optical path (including the light source) of light reaching the eyes of the viewer 16 is vibrated mechanically and randomly at a very small amplitude. This makes it possible to use an existing video display device as it is without the need for changing the basic configuration of the video display control section or the display unit.

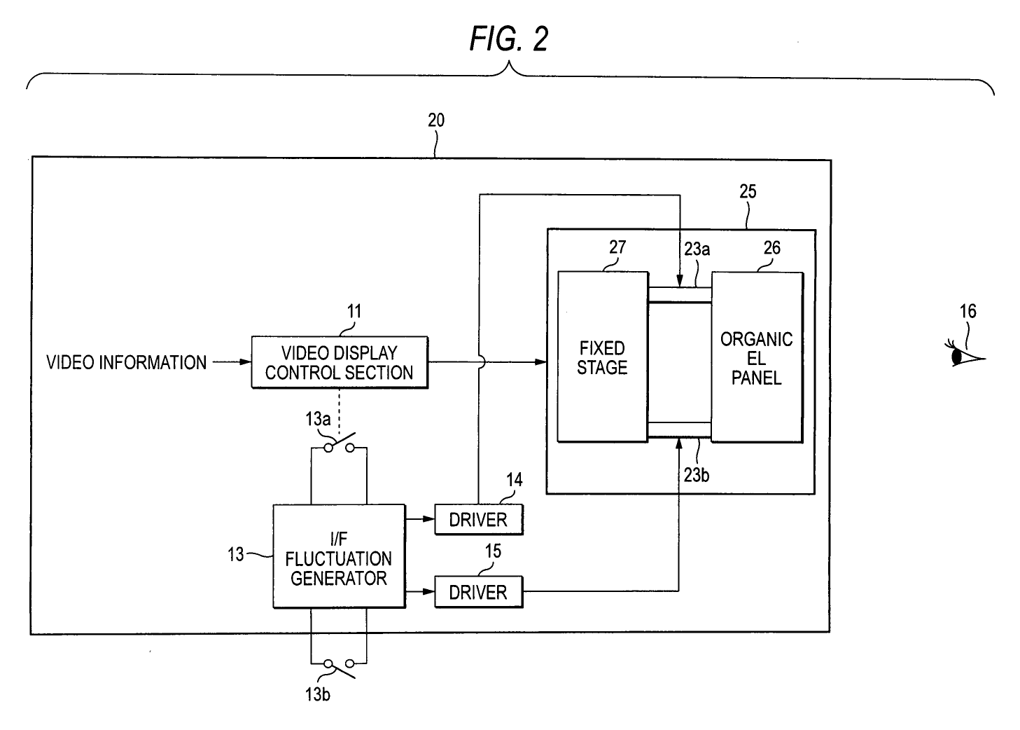

FIG. 2 is a block diagram showing the configuration of a main part of a video display device according to a second embodiment of the invention. The video display device 20 according to this embodiment is the same, in basic configuration, as the video display device 10 according to the first embodiment which has been described above with reference to FIG. 1, and is different from the latter in a display unit 25.

In the display unit 25 according to this embodiment, an organic EL panel 26 is used in place of the liquid crystal display panel 22 shown in FIG. 1. Since the organic EL device is a spontaneous light emission device, the backlight 21 shown in FIG. 1 is not necessary. Therefore, in this embodiment, a fixed stage 27 is provided instead of the backlight 21 shown in FIG. 1 and the organic EL panel 26 is mechanically linked to the fixed stage 27 by piezoelectric elements 23a and 23b.

In this embodiment, the video display device 20 is caused to operate in the same manner as in the first embodiment, whereby the viewer 16 is allowed to watch movie-film-like high-resolution video. However, in this embodiment, it is useless to vibrate the interval between the fixed stage 27 and the organic EL panel 26 at a very small amplitude. Therefore, this operation mode is not provided.

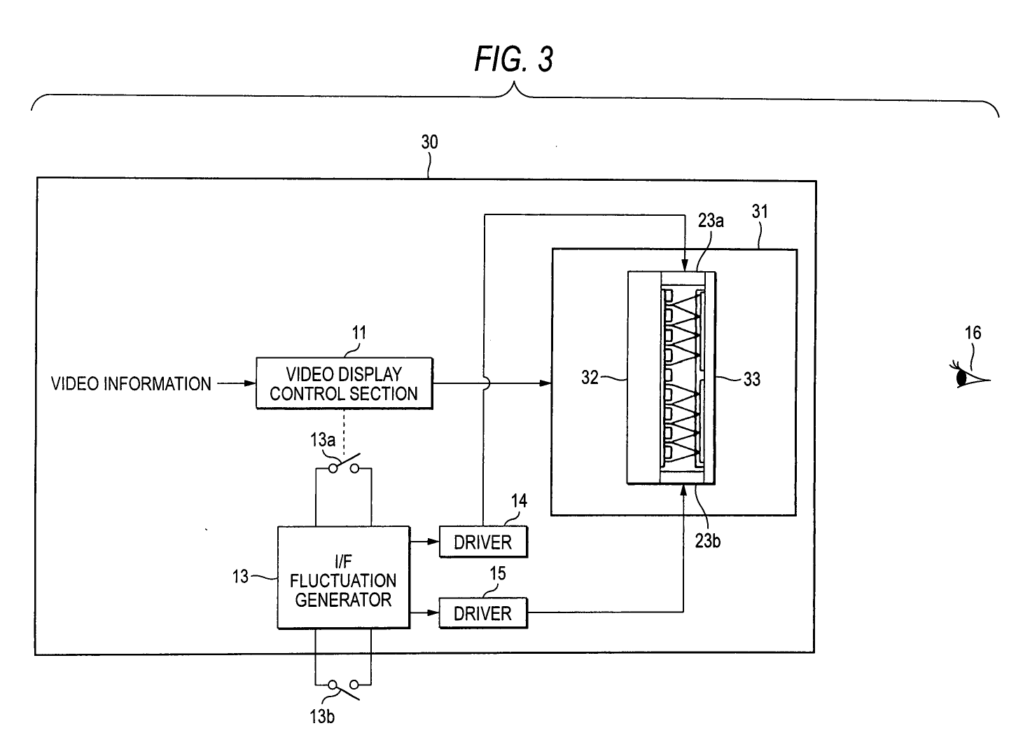

FIG. 3 is a block diagram showing the configuration of a main part of a video display device according to a third embodiment of the invention. The video display device 30 according to this embodiment is the same, in basic configuration, as the video display device 10 according to the first embodiment which has been described above with reference to FIG. 1, and is different from the latter in a display unit 31.

The display unit 31 of this embodiment is a field emission display (FED). The FED 31 is equipped with a back substrate 32 on which cathode electrodes and gate electrodes are formed on its front surface and a front glass substrate 33 which is provided in front of the back substrate 32 so as to be spaced from it and in which phosphors and anode electrodes are formed on its back-substrate-32-side surface. Furthermore, in this embodiment, the entire circumferential portion of the back substrate 32 is mechanically linked to that of the front glass substrate 33 by plural piezoelectric elements 23a and 23b.

Although the FED 31 has various types such as a carbon nanotube type, a Spint type, and an SED type, the concept of the first embodiment can be applied to any of these types of FED device as long as it is provided with a back substrate and a front substrate.

The operation of the video display device 30 according to this embodiment is entirely the same as that of the video display device 10 according to the first embodiment. The viewer 16 is allowed to watch movie-film-like high-resolution video by mechanically vibrating the interval or the inclination angle between the back substrate 32 and the front glass substrate 33 at a very small amplitude according to 1/f fluctuation.

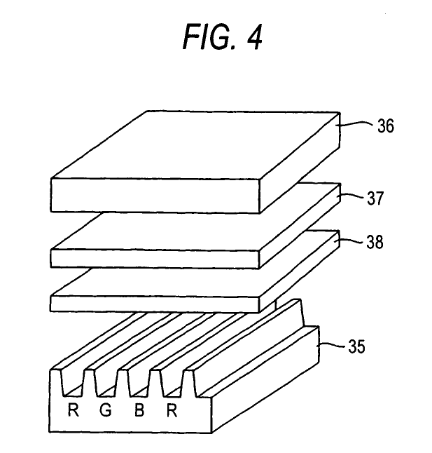

FIG. 4 is an explanatory diagram of a display unit used in a video display device according to a fourth embodiment of the invention. The video display device according to this embodiment is the same, in configuration, as the video display device 10 according to the first embodiment shown in FIG. 1, and is different from the latter in that the display unit is a plasma display panel (PDP) having a stripe structure.

In the PDP having a stripe structure, as shown in FIG. 4, a protective layer 38 and a dielectric layer 37 which is provided with transparent bus electrodes are sandwiched between a front glass substrate 36 and a back substrate 35 which is provided with stripe-shaped partition walls, phosphors, and address electrodes.

Where the above PDP is used as the display unit, the blurring state of light that reaches the eyes of the viewer can be controlled according to 1/f fluctuation and the viewer is allowed to watch movie-film-like high-resolution video by mechanically vibrating one or both of the interval between the front glass substrate 36 and the dielectric layer 37 and the interval between the dielectric layer 37 and the protective layer 38 at a very small amplitude according to 1/f fluctuation.

The same advantages can be obtained by vibrating the inclination angle between the front glass substrate 36 and the other constituent members 35, 37, and 38 or the angle between the combination of the substrate 36 and the dielectric layer 37 and the combination of the protective layer 38 and the back substrate 35 at a very small amplitude.

It is also possible to fix the integral assembly of the front glass substrate 36, the dielectric layer 37, the protective layer 38, and the back substrate 35 to the fixed stage 27 shown in FIG. 27 with the piezoelectric elements 23a and 23b and vibrating the former at a very small amplitude perpendicularly to or parallel with the screen.

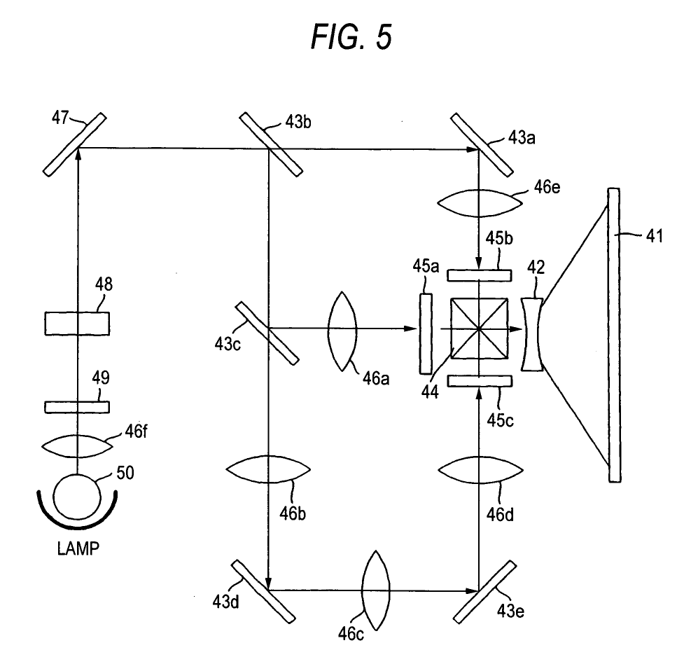

FIG. 5 is an explanatory diagram of a display unit used in a video display device according to a fifth embodiment of the invention. The digital video display device according to this embodiment is the same, in configuration, as the video display device 10 according to the first embodiment shown in FIG. 1, and is different from the latter in that the display unit is a rear projection display.

The rear projection display shown in FIG. 5 is of a 3-LCD (liquid crystal display) type and is equipped with a projection lens 42 for projecting an enlarged optical image of video on a screen 41 and a dichroic prism 44 for combining light beams passed through three LCDs 45a-45c and inputting resulting light to the projection lens 42. Video signals are input to the three respective LCDs 45a-45c from the video display control section 11 shown in FIG. 1.

Alight source 50 is a halogen lamp, for example. Emitted light is passed through an integrator lens 49 and a polarization converting element 48, path-bent by a total reflection mirror 47, and separated into three light beams, which take different optical paths to enter the three respective LCDs 45a-45c. To this end, dichroic mirrors 43a-43e and condenser lenses 46a-46f are disposed at appropriate positions.

The first optical path is the light source 50→lens 46f→integrator lens 49→polarization converting element 48→total reflection mirror 47→dichroic mirror 43b→dichroic mirror 43c→lens 46a→LCD 45a→prism 44→projection lens 42→screen 41.

The second optical path is the light source 50→lens 46f→integrator lens 49→polarization converting element 48→total reflection mirror 47→dichroic mirror 43a→lens 46e→LCD 45b→prism 44→projection lens 42→screen 41.

The third optical path is the light source 50→lens 46f→integrator lens 49→polarization converting element 48→total reflection mirror 47→dichroic mirror 43b→lens 46b→dichroic mirror 43d→lens 46c→dichroic mirror 43e→lens 46d→LCD 45c→prism 44→projection lens 42→screen 41.

For example, this display unit is configured in such a manner that one or plural ones of the members 41, 42, 44, 45a-45c, 46a-46f, and 49 are provided inside the display unit by using the above-described piezoelectric elements or the like. The one or plural ones of those members are vibrated mechanically at a small amplitude perpendicularly to the optical path.

Alternatively, one or plural ones of the members 41, 42, 44, 45a-45c, 48, and 49 are vibrated mechanically at a small amplitude parallel with the optical path.

As another alternative, the inclination, with respect to the optical axis, of one or plural ones of the members 43a-43e, 44, 45a-45c, 46a-46f, 47, 48, and 49 are vibrated mechanically at a small amplitude. The combination of the members to be vibrated and the vibration directions may be set in various manners; for example, it is possible to mechanically vibrate a certain member perpendicular to the optical axis and mechanically vibrate another member parallel with the optical axis.

As in the previous embodiments, the viewer is allowed to watch movie-film-like high-resolution video by mechanically vibrating one or some of the members on the optical paths of the rear projection display (display unit) randomly (preferably according to 1/f fluctuation).

Although the fifth embodiment is directed to the case that the rear projection display is of the 3-LCD type, the rear projection display structure of FIG. 5 is not the only one to which the concept of this embodiment can be applied. The concept of this embodiment can also be applied to various rear projection displays such as a 3-panel RGB rear projection display.

The invention can also be applied to display devices using a CRT (cathode-ray tube). This can be implemented by defocusing an electron beam according to 1/f fluctuation. More specifically, the position, relative to the electron gun, of an electromagnetic lens coil for focusing an electron beam emitted from the electron gun may be vibrated mechanically at a very small amplitude. Alternatively, the voltage applied to the coil may be vibrated mechanically a very small amplitude.

Capable of displaying digital or analog video information as a movie-film-like image, the video display device according to the invention is useful when applied to large-screen flat displays etc.

This application is based on Japanese Patent application JP 2006-264879, filed Sep. 28, 2006, the entire content of which is hereby incorporated by reference, the same as if fully set forth herein.

Although the invention has been described above in relation to preferred embodiments and modifications thereof, it will be understood by those skilled in the art that other variations and modifications can be effected in these preferred embodiments without departing from the scope and spirit of the invention.

What is claimed is:

1. A video display device comprising:
a display unit for displaying video information on a screen; and
a mechanical vibrating unit for vibrating at least one of constituent members including a light source that exist on an optical path, starting from the light source, of the display unit, mechanically and randomly at a very small amplitude.

2. The video display device according to claim 1, comprising a 1/f fluctuation generating unit for giving 1/f fluctuation to the very small vibration.

3. The video display device according to claim 1, wherein the mechanical vibrating unit is attached to the display unit so as to vibrate the at least one constituent member perpendicularly to or parallel with the optical path at a very small amplitude or to vibrate an angle of the at least one constituent member with respect to the optical path at a very small amplitude.

4. The video display device according to claim 2, wherein the mechanical vibrating unit is attached to the display unit so as to vibrate the at least one constituent member perpendicularly to or parallel with the optical path at a very small amplitude or to vibrate an angle of the at least one constituent member with respect to the optical path at a very small amplitude.

5. The video display device according to claim 1, wherein the mechanical vibrating unit is attached to the display unit so as to vibrate an interval between two of the constituent members at a very small amplitude.

6. The video display device according to claim 2, wherein the mechanical vibrating unit is attached to the display unit so as to vibrate an interval between two of the constituent members at a very small amplitude.

7. The video display device according to claim 1, wherein the display unit comprises a backlight and a liquid crystal display panel.

8. The video display device according to claim 2, wherein the display unit comprises a backlight and a liquid crystal display panel.

9. The video display device according to claim 1, wherein the display unit comprises an organic EL panel.

10. The video display device according to claim 2, wherein the display unit comprises an organic EL panel.

11. The video display device according to claim 1, wherein the display unit comprises a field emission display.

12. The video display device according to claim 2, wherein the display unit comprises a field emission display.

13. The video display device according to claim 1, wherein the display unit comprises a plasma display panel.

14. The video display device according to claim 2, wherein the display unit comprises a plasma display panel.

15. The video display device according to claim 1, wherein the display unit comprises a rear projection display.

16. The video display device according to claim 2, wherein the display unit comprises a rear projection display.
